(19) United States
(12) Patent Application Publication
(10) Pub. No.: US 2009/0186576 A1
(43) Pub. Date: Jul. 23, 2009

(54) Bluetooth car kit

(76) Inventor: Ying Hua Peng, Montreal-Nord (CA)

Correspondence Address: YING HUA PENG, 11221 ARMAND-LAVERGNE, MONTREAL-NORD, QC, H1H 5W3, CA

(21) Appl. No.: 12/009,260

(22) Filed: Jan. 18, 2008

(51) Int. Cl. H04B 7/00

(52) U.S. Cl. 455/41.2

(57) ABSTRACT

The “Bluetooth Car Kit” is a new and unique product combining Bluetooth hands-free cell phone calling and USB/SD/MMC supporting FM transmission. The integrated FM Transmitter streams stereo music from its own USB disk, or SD/MMC card through the in-car sound system for music play, playback as well as music select. The “Bluetooth Car Kit” has an audio cable line-in hole which is used to connect any audio device. The “Bluetooth Car Kit” also has the function of hands-free speaking. The “Bluetooth Car Kit” just simply connects to the cigarette lighter socket in the vehicle making it easily transportable. The integrated 1.5 inch LCD display can show multi-information from both of its own USB disk/SD/MMC card as well as the cell phone Bluetooth. The appearance of the “Bluetooth Car Kit” is unique.

### BRIEF DESCRIPTION OF THE DRAWINGS

FIG. 1 is a left-front solid view of “Bluetooth Car Kit” showing my design. There is a button called as “Bluetooth” which is located on the right-top side of the transmitter. And pushing this button one time can go to connect to mobile phone or internet. Pushing this button again gets to cut off the connection.

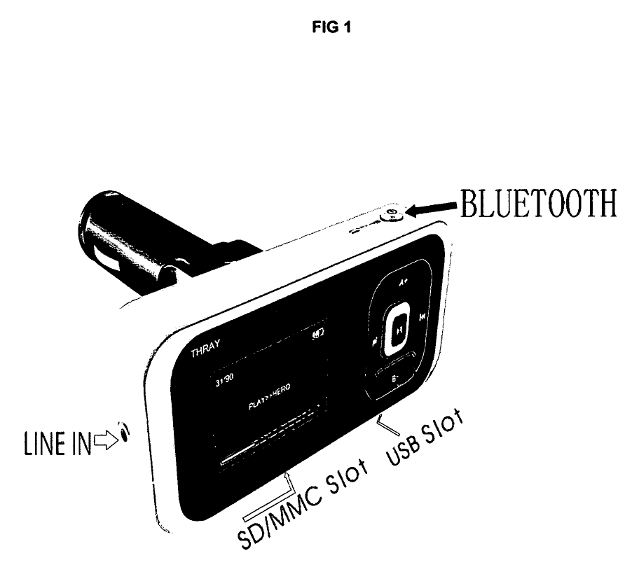

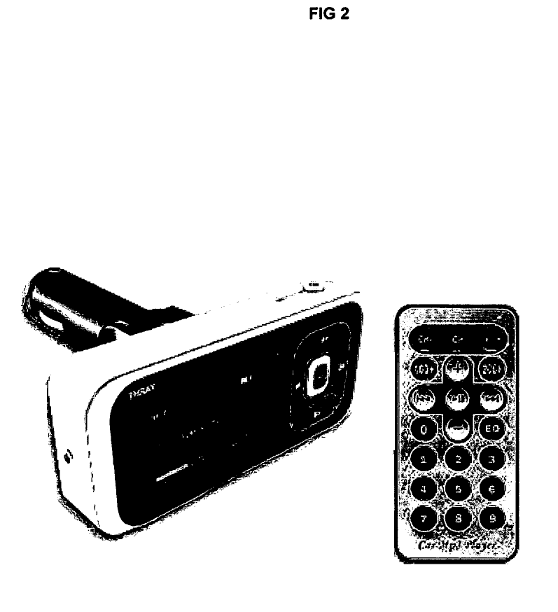

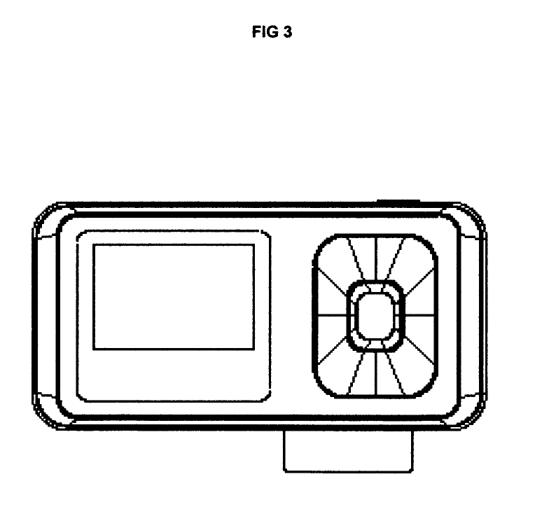

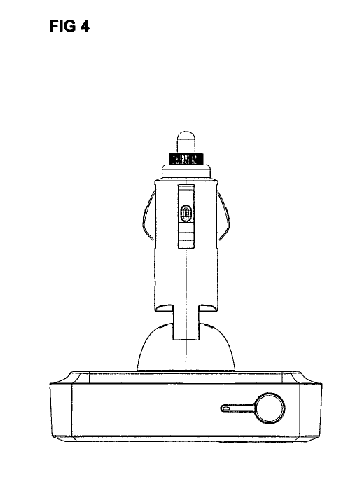

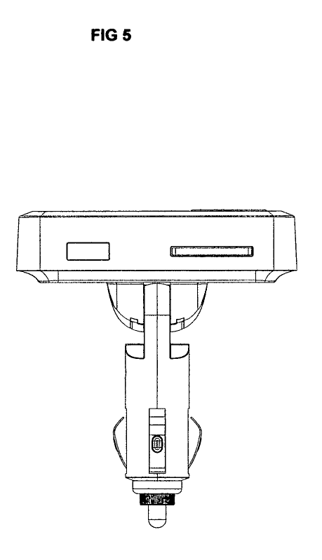

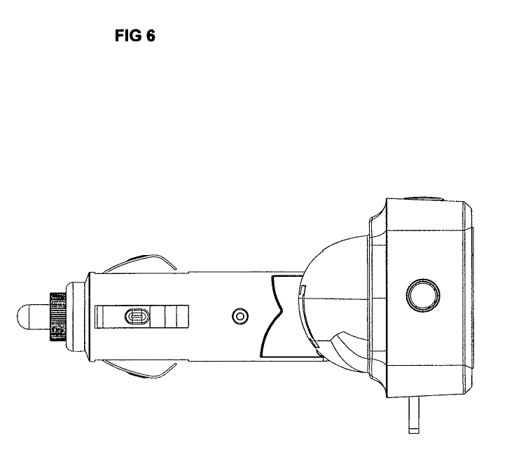

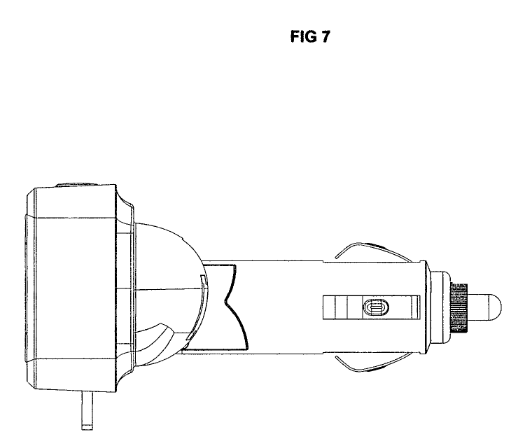

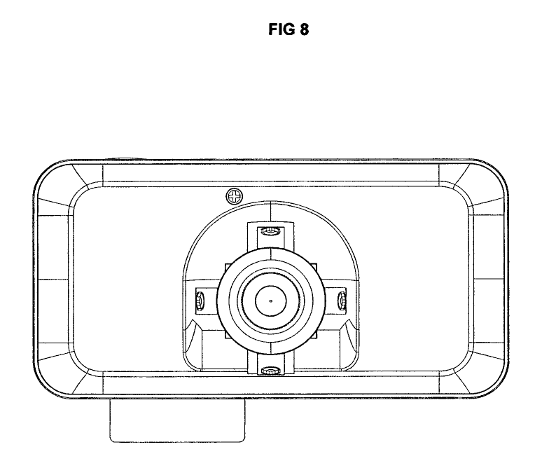

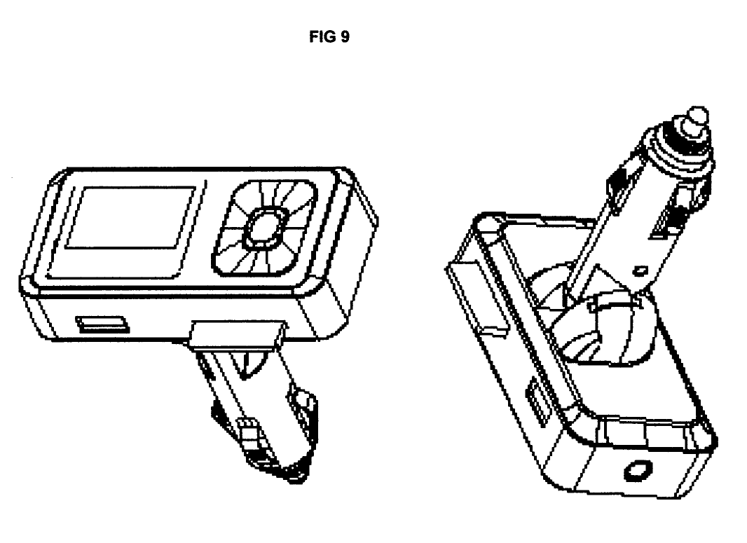

On the front left-side is the 1.5 inch LCD which can show larger characters while adjusting a certain function.

Beside the LCD, there is a key-plate which can control/change FM, volume, as well as operation status.

On the bottom-side surface, there are SD/MMC slot and USB slot, which can separately be connected to SD/MMC card or USB card to play music/songs through the in-car sound system.

On the left-side surface, there is an audio cable line-in hole, which can be used to connect any audio device.

On the left-side of “Bluetooth button”, there is a microphone hole, which can be used by users to hands-free speak.

FIG. 2 is an another left-front solid view of “Bluetooth Car Kit” showing with a new “21-keys” remote-controller. All functions of “Bluetooth Car Kit” can be easily realized by the “21-keys” Remote-controller showed in FIG. 2.

FIG. 3 is front-view of “Bluetooth Car Kit”.

FIG. 4 is top-view of “Bluetooth Car Kit”.

FIG. 5 is bottom-view of “Bluetooth Car Kit”.

FIG. 6 is left-side view of “Bluetooth Car Kit”.

FIG. 7 is right-side view of “Bluetooth Car Kit”.

FIG. 8 is behind view of “Bluetooth Car Kit”.

FIG. 9 is three-dimension views of “Bluetooth Car Kit”.

### DESCRIPTION OF THE INVENTION

The “Bluetooth Car Kit” is a new and unique product combining Bluetooth hands-free cell phone calling and USB/SD/MMC supporting FM transmission. The integrated FM Transmitter streams stereo music from its own USB disk/SD/MMC card through the in-car sound system for music play, playback as well as music select. The “Bluetooth Car Kit” just simply connects to the cigarette lighter socket in the vehicle making it easily transportable. The integrated 1.5 inch LCD display can show multi-information from both its own USB disk/SD/MMC card as well as the cell phone Bluetooth. The “Bluetooth Car Kit” is well-knit, portable, and convenient to put on or off.

### Key Functions

Support SD/MMC card, USB-disk, and Audio cable (line in) to play music/songs through the in-car sound system. The music/songs can be selected by remote controller.
FM Transmitter with Full frequency (87.7 HZ-108.0 HZ, total 204 channels) transmission.
Support Bluetooth function for cell phone connection.
Support call ID show and handsfree function. The incoming call will get through automatically. 10 calling numbers can be stored by “Bluetooth Car Kit” automatically, and just pushing 0-9 keys on the remote controller to call.
The integrated 1.5 inch LCD display can adjust characters on the LCD.
Bluetooth reconnection automatically after being broken off or getting out of unavailable-net area.
Combination of Bluetooth function and USB/SD/MMC supporting FM transmission, which can transfer both functions smoothly.

### Technical Specifications

FM Transmitter Freq Range: 87.7 HZ-108.0 HZ, total 204 channels
Operating Voltage Range: 12-18 Vdc
Weight: 100 g
Dimensions: 100 mm×90 mm×50 mm; (controller) 90 mm×40 mm×8 mm
Screen: 1.5 inch LCD display
Controller with 21 key new Remote
Default status when power on: FM frequency on 88.1 HZ, EQ mode on Normal, volume on maximum.
Audio cable In/out: 3.5 mm
SD/MMC card: Standard
USB-disk: Standard

1. The Utility design for a Bluetooth modulator used in vehicles, as shown and described.
The small entity status (37 CFR 1.27)
Convention Priority
